(19) United States
(12) Patent Application Publication
(10) Pub. No.: US 2026/0267764 A1
(43) Pub. Date: Sep. 10, 2026

(54) ADAPTIVE FRAME PARTITIONING IN ACCELERATED SYSTEMS

(71) Applicant: NVIDIA Corporation, Santa Clara, CA (US)

(72) Inventors: Jun LIU, Shenzhen (CN); Qian ZHAN, Shanghai (CN); Feng ZHOU, Shanghai (CN); Hang CHEN, Shenzhen (CN); Rongrong ZHOU, Shenzhen (CN)

(73) Assignee: NVIDIA Corporation, Santa Clara, CA (US)

(21) Appl. No.: 19/075,241

(22) Filed: Mar. 10, 2025

(30) Foreign Application Priority Data
Mar. 6, 2025 (CN) 202510264588X

(51) Int. Cl. G06F 11/34; H04L 43/0852; H04L 43/0888

(52) U.S. Cl. CPC G06F 11/3447; H04L 43/0852; H04L 43/0888

(57) ABSTRACT

Various examples, systems, and methods are disclosed relating to a slicing pipeline. A first computing system can process, by a processing component of a system-on-chip (SoC), at least one first frame into a plurality of first slices based at least on a first slice parameter. The first computing system further can update at least one performance metric based at least on timing data corresponding with the processing of the plurality of first slices. The first computing system further can determine a second slice parameter based at least on the at least one performance metric. The first computing system further can apply, in real-time, the second slice parameter to the processing component to cause subsequence processing of at least one second frame into a plurality of second slices based at least on the second slice parameter.

### CROSS-REFERENCE TO RELATED APPLICATIONS

The present application claims priority to Chinese Patent Application No. 202510264588X, filed on Mar. 6, 2025.

### BACKGROUND

Managing frame slicing and transfer in systems that process outputs (e.g., camera data, video frames, image streams, and/or real-time visual data) presents challenges. Some traditional methods rely on static configurations, such as processing entire frames or using fixed slicing strategies, leading to inefficiencies and increased latency. For example, when processing complete frames, systems wait for the entire frame to be transferred before beginning processing, causing idle periods and resource underutilization. Alternatively, fixed frame slicing strategies can reduce idle time but introduce communication overhead, particularly as slices become smaller, which increases the number of transmissions and associated latency. Current methods are inadequate at performing slicing to balance latency and overhead while aligning with the processing capabilities of the system. Additionally, traditional fixed slicing methods can fail to adapt to specific operational constraints, such as minimum slice size requirements or accelerator processing limits. These limitations result in inefficient handling of camera output data, video encoding workflows, and/or any real-time processing pipelines, particularly in systems requiring real-time or near real-time performance (e.g., multi-camera systems, video encoding pipelines, and autonomous applications).

### SUMMARY

Implementations of the present disclosure relate to systems and methods for improving the slicing and processing of frames in systems processing outputs. Systems and methods are disclosed that can dynamically determine frame slicing parameters based on real-time (or near real-time) operational metrics, such as processing capacity, clock frequency, communication latency, frame resolution, and/or any workload characteristics. For example, systems and methods in accordance with the present disclosure can use models (e.g., latency prediction models, random forest machine-learning (ML) model, gradient descent ML model, and/or any artificial intelligence (AI) model) to determine slice sizes based on constraints such as processing limits and minimum slice size requirements. The dynamic adjustments can reduce idle periods, balance communication overhead, and improve processing efficiency for outputs. For example, systems and methods in accordance with the present disclosure can monitor real-time metrics (e.g., slice processing latency, throughput, system utilization, and/or any performance metrics), analyze the impact of slice size on overall system performance, and dynamically update slicing parameters during runtime. The disclosed techniques allow systems to begin processing frame slices as they are received, reducing idle time while managing communication latency. The systems and methods can be applied in various contexts, including multi-camera systems, video encoding pipelines, and real-time applications such as autonomous vehicles or video streaming platforms. By dynamically updating frame slicing parameters, the disclosed systems and methods provide enhanced performance and efficiency in processing outputs.

Although the present disclosure may be described with respect to an example autonomous vehicle 800 (alternatively referred to herein as “vehicle 800” or “ego-vehicle 800,” an example of which is described with respect to FIGS. 8A-8D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to adaptive frame partitioning in accelerated systems (e.g., autonomous driving) this is not intended to be limiting, and the systems and methods described herein may be used in augmented reality, virtual reality, mixed reality, robotics, security and surveillance, autonomous or semi-autonomous machine applications, and/or any other technology spaces where adaptive frame partitioning may be used.

Some implementations relate to a system, including one or more processors. The one or more processors are to process, by a processing component of a system-on-chip (SoC), at least one first frame into a plurality of first slices based at least on a first slice parameter. The one or more processors are to update at least one performance metric based at least on timing data corresponding with the processing of the plurality of first slices. The one or more processors are to determine a second slice parameter based at least on the at least one performance metric. The one or more processors are to apply, in real-time, the second slice parameter to the processing component to cause subsequence processing of at least one second frame into a plurality of second slices based at least on the second slice parameter.

In some implementations, the one or more processors are to initialize the processing component based at least on updating a static configuration including at least one operational parameter corresponding with at least one connected device. In some implementations, the at least one performance metric includes at least one of (i) a processing time of the plurality of first slices, (ii) a communication delay corresponding with providing the plurality of first slices from a slicing component to the processing component, (iii) a throughput corresponding with the plurality of first slices processed by the processing component, or (iv) a ratio of the communication delay to the processing time of the plurality of first slices.

In some implementations, the timing data corresponds to at least one of (i) a plurality of time stamps representing a start of processing and an end of processing for the plurality of first slices, (ii) a duration between a transmission of the plurality of first slices from a slicing component and a completion of processing by the processing component, (iii) an interval between a plurality of consecutive transmissions of the plurality of first slices from the slicing component, or (iv) a cumulative processing time of the plurality of first slices. In some implementations, the second slice parameter is further determined based at least on maintaining the second slice parameter within at least one operational range of the processing component.

In some implementations, the second slice parameter is further determined based at least on updating, using at least one artificial intelligence (AI) model, the second slice parameter to satisfy the at least one operational range of the processing component and based at least on the at least one performance metric corresponding to a frame rate of the at least one first frame, a clock frequency of the processing component, a communication delay, and a processing overhead. In some implementations, the at least one AI model corresponds to a random forest regression model or a gradient descent model, and wherein the updating of the at least one performance metric and the determining of the second slice parameter and a plurality of subsequent slice parameters is periodically performed during runtime of the processing component.

In some implementations, the one or more processors are to update the at least one performance metric based at least on a processing of at least one third frame into a plurality of third slices based at least one the second slice parameter. In some implementations, the one or more processors are to determine a third slice parameter based at least on the at least one performance metric. In some implementations, the one or more processors are to apply, in real-time, the third slice parameter to the processing component to cause subsequence processing of at least one fourth frame into a plurality of fourth slices based at least on the third slice parameter. In some implementations, the plurality of first slices represent a sub-section of the at least one first frame, and wherein the second slice parameter is applied to the processing component by updating a slicing configuration.

Some implementations relate to one or more processors including processing circuitry to process, by a processing component of a system-on-chip (SoC), at least one first frame into a plurality of slices based at least on a first slice parameter. The processing circuitry is to determine at least one metric based at least on timing data corresponding with the processing of the plurality of slices. The processing circuitry is to determine a second slice parameter based at least on the at least one metric. The processing circuitry is to apply, in real-time, the second slice parameter to the processing component to cause subsequence processing of at least one second frame based at least on the second slice parameter.

In some implementations, the processing circuitry is to initialize the processing component based at least on updating a static configuration including at least one operational parameter corresponding with at least one connected device. In some implementations, the at least one metric includes at least one of (i) a processing time of the plurality of slices, (ii) a communication delay corresponding with providing the plurality of slices from a slicing component to the processing component, (iii) a throughput corresponding with the plurality of slices processed by the processing component, or (iv) a ratio of the communication delay to the processing time of the plurality of slices.

In some implementations, the timing data corresponds to at least one of (i) a plurality of time stamps representing a start of processing and an end of processing for the plurality of slices, (ii) a duration between a transmission of the plurality of slices from a slicing component and a completion of processing by the processing component, (iii) an interval between a plurality of consecutive transmissions of the plurality of slices from the slicing component, or (iv) a cumulative processing time of the plurality of slices. In some implementations, the second slice parameter is further determined based at least on maintaining the second slice parameter within at least one operational range of the processing component.

In some implementations, the second slice parameter is further determined based at least on updating, using at least one artificial intelligence (AI) model, the second slice parameter to satisfy the at least one operational range of the processing component and based at least on the at least one metric corresponding to a frame rate of the at least one first frame, a clock frequency of the processing component, a communication delay, and a processing overhead. In some implementations, the at least one AI model corresponds to a random forest regression model or a gradient descent model, and wherein the updating of the at least one metric and the determining of the second slice parameter and a plurality of subsequent slice parameters is periodically performed during runtime of the processing component.

In some implementations, the processing circuitry is to update the at least one metric based at least on a processing of at least one third frame into a plurality of second slices based at least one the second slice parameter. In some implementations, the processing circuitry is to determine a third slice parameter based at least on the at least one metric. In some implementations, the processing circuitry is to apply the third slice parameter to the processing component to cause subsequence processing of at least one fourth frame into a plurality of third slices based at least on the third slice parameter. In some implementations, the plurality of slices represent a sub-section of the at least one first frame, and wherein the second slice parameter is applied to the processing component by updating a slicing configuration.

Some implementations relate to a method. The method includes processing, using one or more processors by a processing component of a system-on-chip (SoC), at least one first frame into a plurality of first slices based at least on a first slice parameter. The method includes updating, using the one or more processors, at least one performance metric based at least on timing data corresponding with the processing of the plurality of first slices. The method includes determining, using the one or more processors, a second slice parameter based at least on the at least one performance metric. The method includes applying, using the one or more processors in real-time, the second slice parameter to the processing component to cause subsequence processing of at least one second frame into a plurality of second slices based at least on the second slice parameter.

The processors, systems, and/or methods described herein can be implemented by or included in at least one of a system for performing collaborative content creation for 3D assets, a system for performing deep learning operations, a system for generating or presenting one or more of augmented reality content, virtual reality content, or mixed reality content, a system for performing simulation operations, a system for performing real-time streaming, a system implementing one or more multi-model language models, a system implementing one or more large language models (LLMs), a system implementing one or more small language models (SLMs), a system implementing one or more vision language models (VLMs), a system for generating synthetic data, a system for generating synthetic data using AI, a control system for an autonomous or semi-autonomous machine, a perception system for an autonomous or semi-autonomous machine, a system for performing digital twin operations, a system for performing light transport simulation, a system for performing remote operations, a system implemented using an edge device, a system implemented using a robot, a system for performing conversational AI operations, a system incorporating one or more virtual machines (VMs), a system implemented at least partially in a data center, and/or a system implemented at least partially using cloud computing resources.

### BRIEF DESCRIPTION OF THE DRAWINGS

The present systems and methods for adaptive frame partitioning in accelerated systems are described in detail below with reference to the attached drawing figures, wherein:

FIG. 1 is a block diagram of an example of a system, in accordance with some implementations of the present disclosure;

FIG. 2 is a flow diagram of an example of a method for adaptative frame partitioning in accelerated systems in a slicing pipeline, in accordance with some implementations of the present disclosure;

FIG. 3 is a block diagram of a slicing pipeline system including an accelerator system, a metric system, a slice system, and a downstream system, in accordance with some implementations of the present disclosure;

FIG. 4 is an example illustration of a diagram and slice parameters and a graph depicting example prediction error versus actual latency, in accordance with some implementations of the present disclosure;

FIG. 5A is a block diagram of an example generative language model system suitable for use in implementing at least some implementations of the present disclosure;

FIG. 5B is a block diagram of an example generative language model that includes a transformer encoder-decoder suitable for use in implementing at least some implementations of the present disclosure;

FIG. 5C is a block diagram of an example generative language model that includes a decoder-only transformer architecture suitable for use in implementing at least some implementations of the present disclosure;

FIG. 6 is a block diagram of an example computing device suitable for use in implementing at least some implementations of the present disclosure;

FIG. 7 is a block diagram of an example data center suitable for use in implementing at least some implementations of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure; and

FIG. 8D is a system diagram for communication between cloud-based server(s) and the example autonomous vehicle of FIG. 8A, in accordance with some embodiments of the present disclosure.

### DETAILED DESCRIPTION

This disclosure relates to systems and methods for dynamic partitioning in accelerators within system-on-chip (SoC) architectures. Modern SoCs (e.g., autonomous driving platforms, video streaming devices, game streaming systems, and/or any high-performance computing systems) often include multiple systems, such as image signal processors (ISPs), encoding systems, and general-purpose compute components (e.g., GPUs, video encoding modules, deep learning accelerators, and/or any hardware acceleration components), to perform high-throughput data processing tasks (e.g., video encoding, real-time multi-camera processing, image enhancement, and/or any data-intensive operations). Traditional methods for data transfer to accelerators, such as frame-by-frame processing, can lead to inefficiencies due to idle periods and resource underutilization. For example, systems can wait for complete frames to be received before processing, resulting in delays. Alternatively, smaller data slices can reduce idle periods but introduce communication overhead (e.g., additional from inter-component communication), which can impact performance beyond a certain threshold (e.g., clock frequency limits or slice size constraints).

Some methods for data partitioning, such as fixed-size slicing or manual adjustments, cannot adequately balance latency reduction and resource usage. These approaches often fail to adapt dynamically (e.g., in response to real-time or near real-time operational parameters) to variations in processing workloads, clock frequencies, and/or the capacity of different systems. For example, fixed-size slicing (e.g., dividing frames into equally-sized blocks without considering performance metrics) can result in less efficient processing under varying conditions, and manual adjustments can introduce inconsistencies. Additionally, such methods can lack flexibility for different applications or workloads, leading to potential inefficiencies in computational resource usage.

Systems and methods in accordance with the present disclosure can improve data transfer techniques by dynamically determining slice sizes based on real-time (or near real-time) operational parameters, such as but not limited to, latency, clock frequency, slice size, and/or system capacity. That is, the disclosed systems and methods can determine slice sizes using a computational model receiving parameters as input, such as but not limited to, processing frequency (e.g., accelerator clock rates), communication latency (e.g., interconnect delay between systems), and/or workload characteristics (e.g., resolution, frame rate, and/or number of active cameras). For example, the system can analyze latency data and determine a slice parameter (e.g., slice size), modeling operational constraints (e.g., system capacity, minimum slice size requirements, overhead from communication latency, processing throughput, and/or any other constraints). The system can dynamically (e.g., periodically or continuously during operation) update slice size configurations during runtime based on feedback from systems regarding latency statistics and workload performance. That is, the dynamic sizing of slice parameters can be applied in a variety of systems, including video streaming, multi-camera systems, real-time gaming platforms, content delivery systems, autonomous vehicle data processing, and/or any other data processing environments.

In some implementations, the systems and methods can determine a slice parameter using a gradient descent model to handle latency while remaining within operational constraints. For example, the system can determine slice parameters that can balance throughput and communication overhead (e.g., without exceeding capacity limits). Additionally, the system can use a processing component (e.g., partitioning system) within the SoC architecture to facilitate initialization and runtime operations. For example, during initialization, systems can load default configurations, including clock frequencies and slice size settings. During runtime, systems can fetch updated slice parameters periodically and/or continuously, report latency statistics, and/or receive recalculated slice sizes to be applied by the processing component (e.g., on subsequent processing of frames). Thus, the systems and methods described herein provide improvements in data partitioning for accelerators or other processing systems within SoCs and/or other computing platforms. That is, by dynamically updating slice parameters based on real-time (or near real-time) data, the disclosed systems and methods improve performance across various workloads and applications.

In some implementations, the system can process at least one first frame into a plurality of first slices based at least on a first slice parameter. For example, the system can process the first frame using a processing component (e.g., accelerator) of a system-on-chip (SoC). Additionally, the system can update at least one performance metric based at least on timing data corresponding with the processing of the plurality of first slices. In some implementations, the system can determine a second slice parameter based at least on the at least one performance metric. Furthermore, the system can apply, in real-time, the second slice parameter to the processing component to cause subsequence processing of at least one second frame into a plurality of second slices based at least on the second slice parameter.

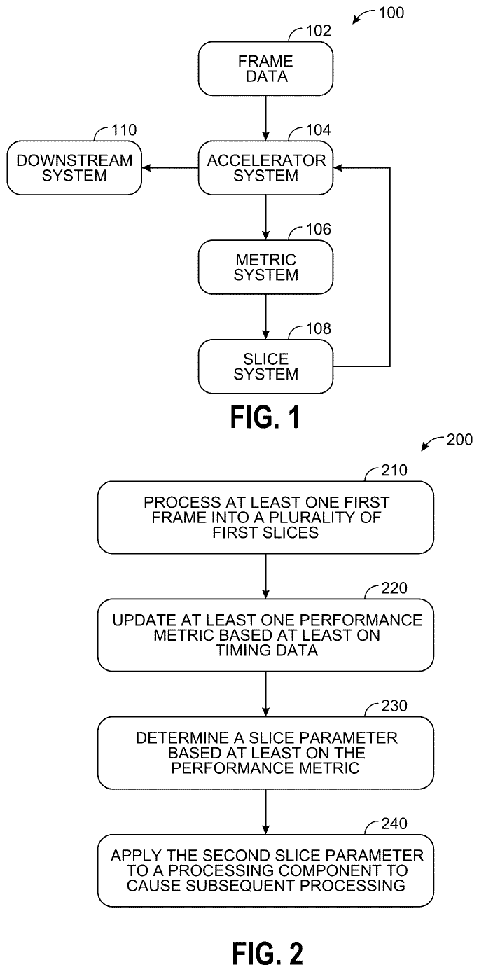

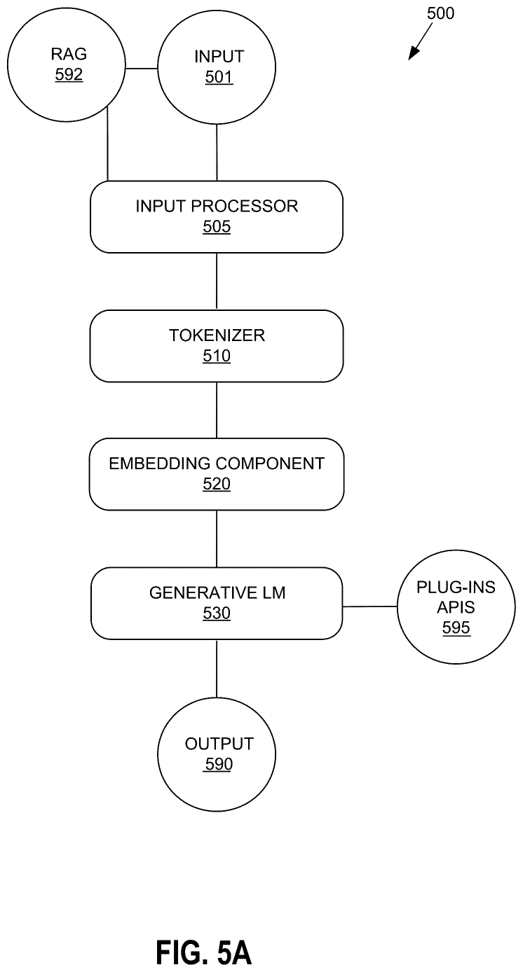

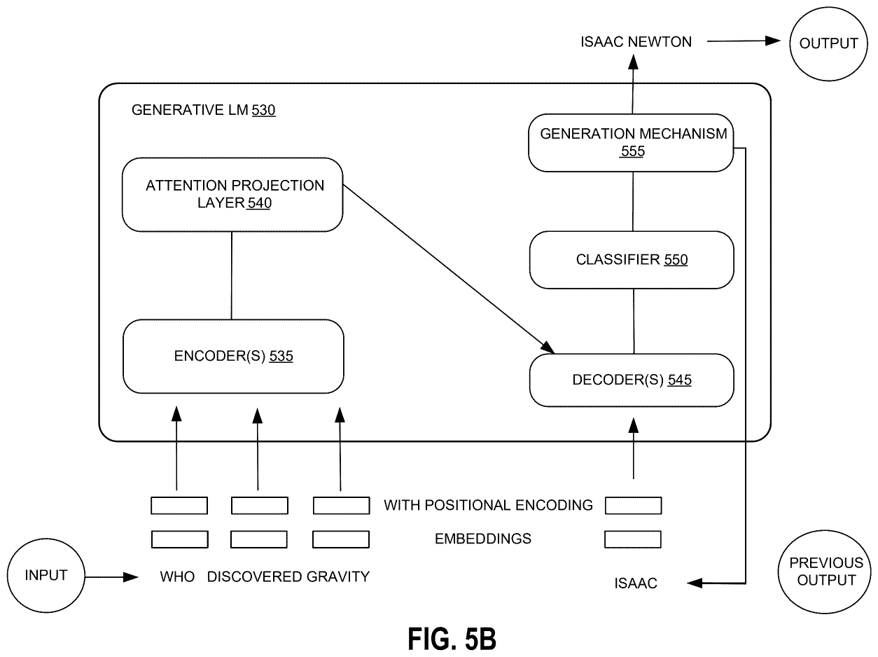

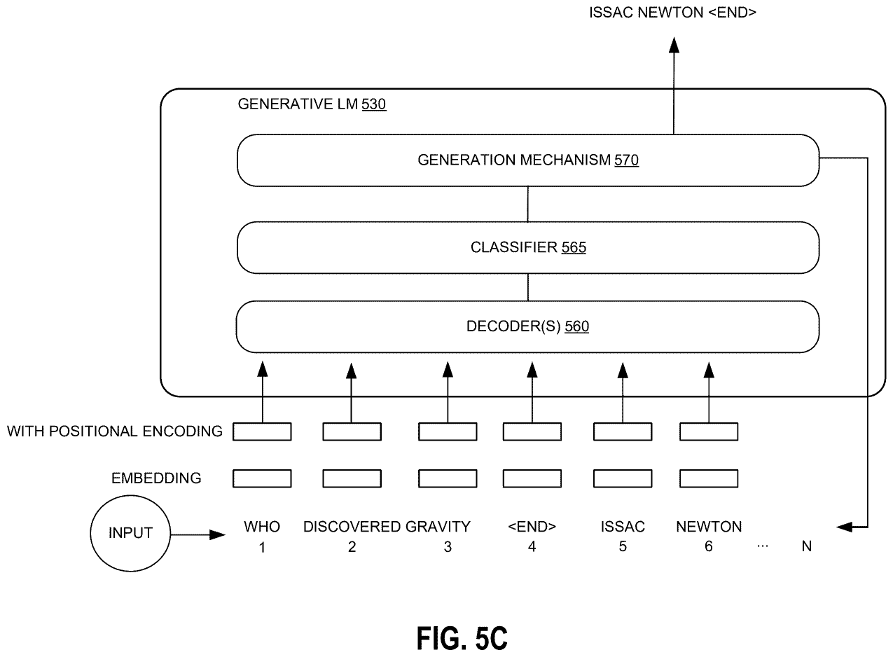

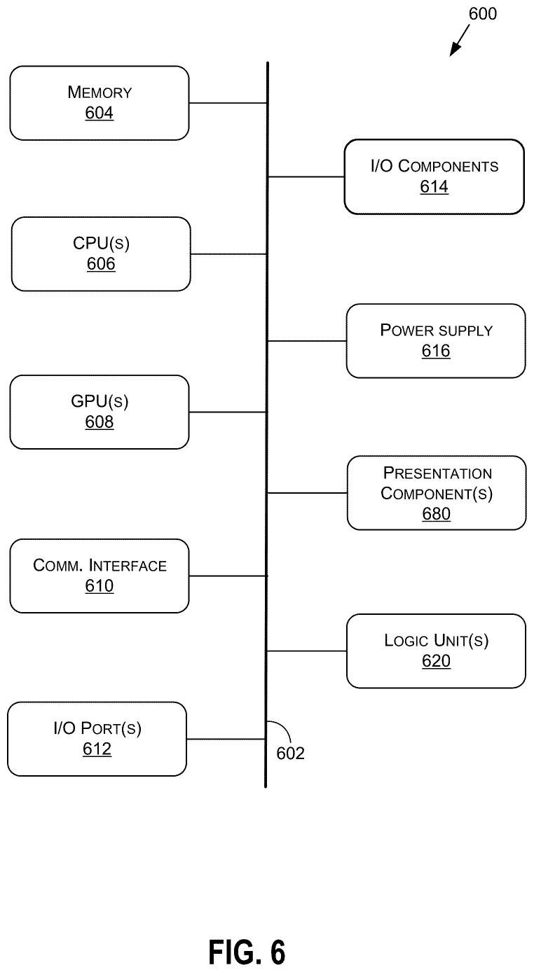

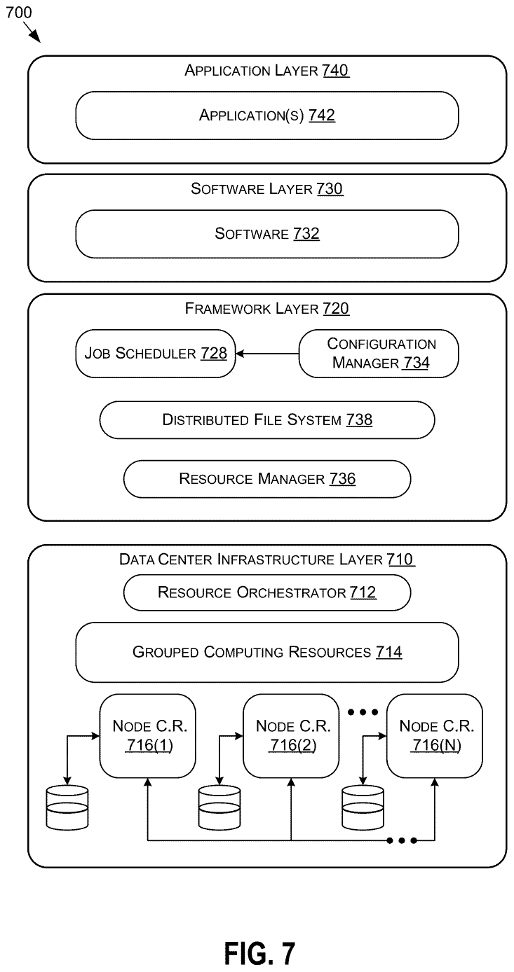

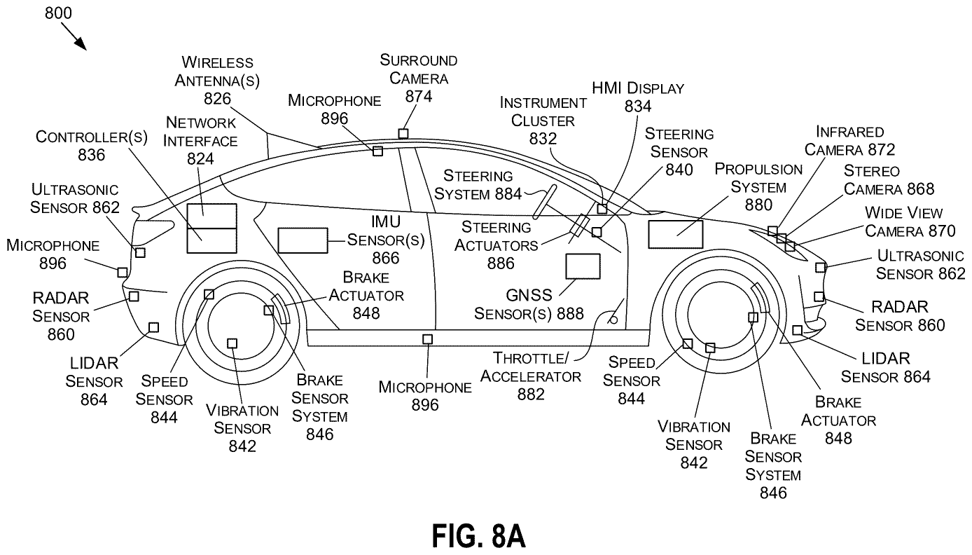

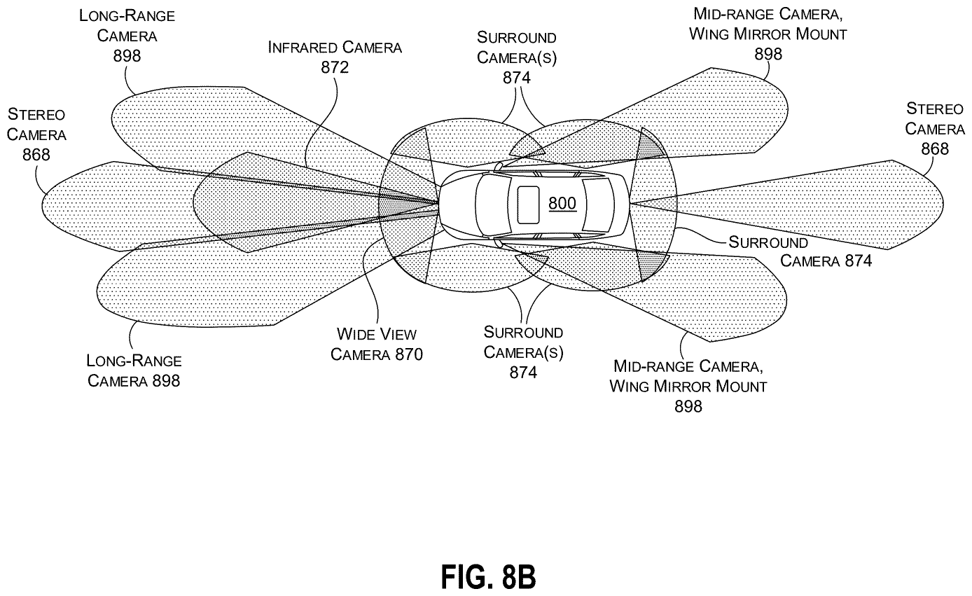

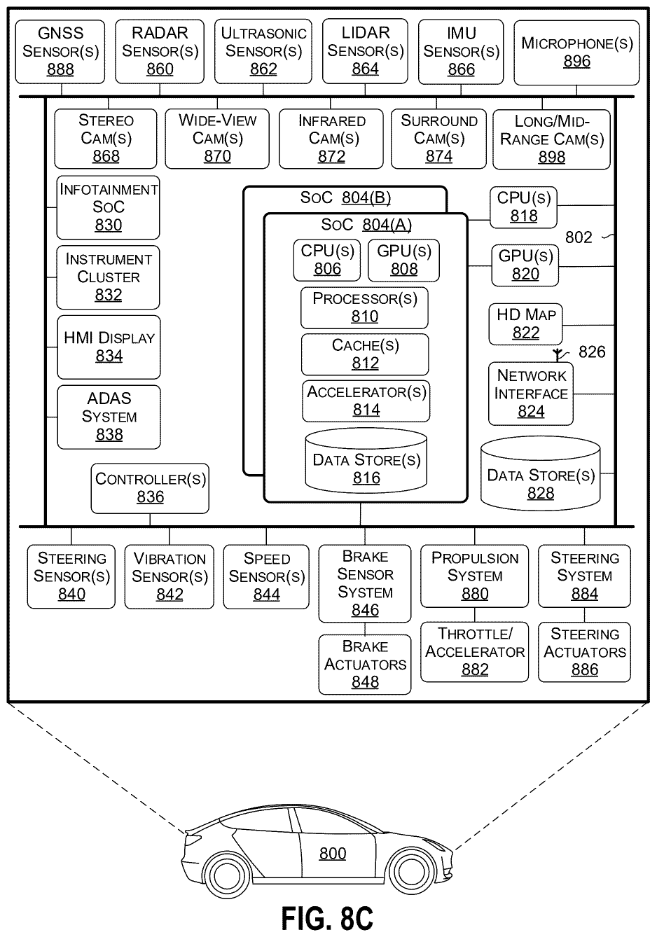

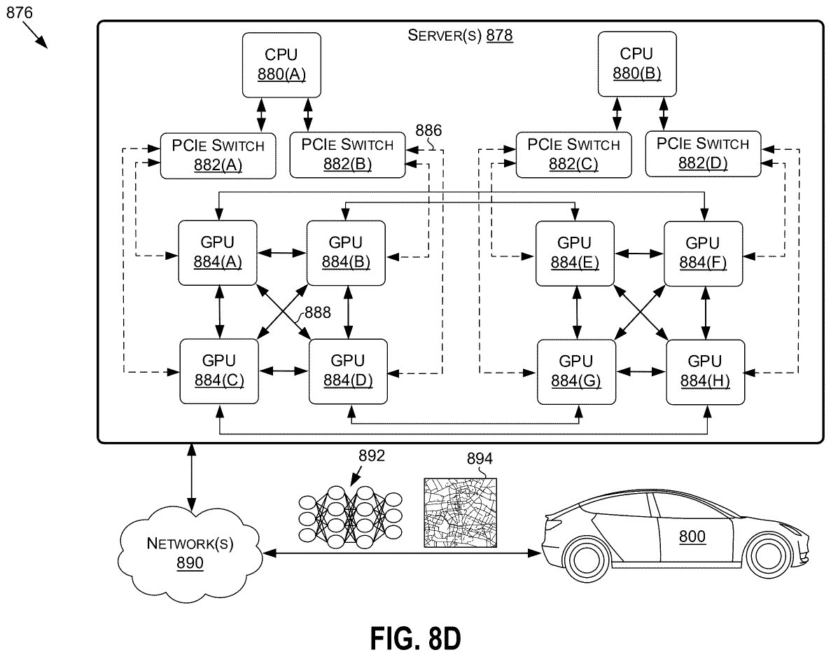

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 500 of FIG. 5A, example generative language model (LM) 530 of FIGS. 5B-5C, example computing device 600 of FIG. 6, example data center 700 of FIG. 7, and/or example autonomous vehicle 800 of FIGS. 8A-8D.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

The system 100 can implement at least a portion of slicing pipeline, such as but not limited to a video encoding pipeline, a data preprocessing pipeline, or a real-time analytics pipeline. The system 100 can be used to reduce processing latency and/or improve system throughput by any of various systems described herein, including but not limited to video surveillance systems, autonomous navigation systems, industrial automation systems, edge computing systems, cloud-based AI systems, medical diagnostics systems, and/or remote sensing systems.

Generally, the slicing pipeline can include operations performed by the system 100. For example, the slicing pipeline can include any one or more of an acceleration stage, a metric stage, a slice stage, and/or a processing stage. Each stage of the slicing pipeline includes one or more components of the system 100 that perform the functions described herein. In some implementations, one or more of the stages can be performed during the training of AI models. Additionally, one or more of the stages can be performed during the inference phase using the AI models.

The system 100 (e.g., implementing the slicing pipeline) can process, by a processing component of a system-on-chip (SoC), at least one first frame into a plurality of first slices based at least on a first slice parameter. In some implementations, implementing the slicing pipeline can include the system 100 updating at least one performance metric based at least on timing data corresponding with the processing of the plurality of first slices. Additionally, the implementing the slicing pipeline can include the system 100 determining a second slice parameter based at least on the at least one performance metric. In some implementations, the implementing the slicing pipeline can include the system 100 applying, in real-time (or near real-time), the second slice parameter to the processing component to cause subsequence processing of at least one second frame into a plurality of second slices based at least on the second slice parameter. Thus, the frame slicing pipeline can improve processing efficiency and reduce idle time in real-time systems.

Additionally, the slice parameter can correspond and/or is otherwise associated with an ISP clock and/or the number of cycles required to process each slice. In some implementations, the slice parameter can be calculated based on the ISP clock frequency (e.g., MHZ) to ensure that slices are processed within the frame interval without exceeding the processing capacity of the ISP. That is, the ISP clock frequency can be used to determine the processing time available for at least one (e.g., each) slice, and the slice parameter can be adjusted accordingly. For example, at an ISP clock frequency of 700 MHz, the slice parameter can be set to ensure that the total processing time for all slices in a frame does not exceed 33 ms for a frame rate of 30 fps. In this example, the slice parameter can be calculated as a function of the frame size, the number of slices, and/or the clock cycles per slice. In another example, if the ISP clock frequency decreases due to system constraints, the slice parameter can be increased to ensure that the processing load does not exceed the reduced capacity of the ISP. In this example, the slice parameter can be adjusted dynamically to account for variations in the ISP clock.

In some implementations, the acceleration stage can be the stage in the slicing pipeline in which the system 100 can prepare the frame data 102 for slicing. The system 100 can include at least one accelerator system 104. The accelerator system 104 (e.g., processing component of a system-on-chip (SoC)) can process at least one first frame (e.g., frame data 102) into a plurality of first slices based at least on a first slice parameter (e.g., slice size). That is, the accelerator system 104 can divide frames into slices dynamically based on runtime parameters. The frame data 102 can be raw video frames, compressed image data, sensor output, metadata, timing data, pixel-level information, spatial characteristics, and/or any visual input data. The accelerator system 104 can include an accelerator (e.g., video encoder, neural processing unit (NPU), graphics processing unit (GPU), and/or any specialized hardware) that can process and partition frames for downstream tasks (e.g., by the downstream system 110). For example, during acceleration stage the accelerator system 104 can receive frame data and generate slices for processing (e.g., according to at least one slice parameter).

In some implementations, the accelerator system 104 can process and/or otherwise partition video frames into slices by applying pre-determined slicing parameter and/or logic. Additionally, the plurality of first slices can represent a sub-section (e.g., portioned portion of a full frame) of the at least one first frame. In some implementations, the system 100 can initialize the accelerator system 104 (e.g., processing component) based at least on updating a static configuration (e.g., default slicing size and resolution settings). That is, updating the static configuration can include identifying and/or otherwise determining at least one operational parameter (e.g., processing speeds, resolutions, frame rates) corresponding with at least one connected device. For example, the connected device can be cameras, video sources, sensors, other peripherals such as gaming consoles or autonomous vehicle systems.

In some implementations, the metric stage can be the stage in the slicing pipeline in which the system 100 can collect and analyze performance data. The system 100 can include at least one metric system 106 (e.g., coupled to and/or part of the slice system 108). The metric system can update at least one performance metric based at least on timing data (e.g., from and/or otherwise derived from the frame data 102) corresponding with the processing of the plurality of first slices. That is, the performance metric can represent system efficiency during frame slicing and processing.

Additionally, the timing data can be at least one temporal measurement derived from processing durations, communications delays, and/or intervals between events (e.g., reception of a slice, start of slice processing, completion of slice processing) during the processing of slices of frames. For example, during metric stage the metric system 106 can analyze timing data to update slice parameters. In some implementations, the metric system 106 can update the performance metric and/or otherwise store latency measurements by logging data periodically during processing. The performance metric can be maintained in ongoing, continuous, and/or dynamic feedback-driven basis, such that real-time (or near real-time) updates are used to refine operations. For example, the performance metric can be a latency threshold used to modify slicing parameters.

In some implementations, the at least one performance metric (e.g., from and/or otherwise derived from the frame data 102) can be a processing time of the plurality of first slices (e.g., time to process at least one (e.g., each) slice by the accelerator system 104). In some implementations, the at least one performance metric can be a communication delay (e.g., time to transmit slices between components) corresponding with providing the plurality of first slices from a slicing component to the processing component. In some implementations, the at least one performance metric can be a throughput (e.g., number of slices processed per second) corresponding with the plurality of first slices processed by the processing component. In some implementations, the at least one performance metric can be a ratio (e.g., latency-to-throughput ratio) of the communication delay to the processing time of the plurality of first slices.

In some implementations, the timing data can correspond to (e.g., indicate, measure) a plurality of time stamps representing a start of processing (e.g., slice received by the accelerator) and an end of processing (e.g., slice processed and transmitted) for the plurality of first slices. The time stamps can be recorded at each significant event (e.g., slice arrival, start of processing, and/or completion of processing). That is, the timing data can be raw measurements from the processing and/or providing the performance metrics including underlying temporal information. In some implementations, the timing data can be a duration (e.g., total processing time, latency interval) between a transmission of the plurality of first slices from the slicing component and a completion of processing by the processing component. The duration can represent the time elapsed between sending a slice and receiving confirmation of its processing. In some implementations, the timing data can be an interval between a plurality of consecutive transmissions (e.g., slice 1 to slice 2 transmission delay, slice batch interval) of the plurality of first slices from the slicing component. In some implementations, the timing data can be a cumulative processing time (e.g., total time for all slices of a frame, sum of slice latencies) of the plurality of first slices.

In some implementations, the metric system 106 can update the at least one performance metric based at least on a processing of at least one third frame into a plurality of third slices based at least one the second slice parameter. That is, the metric system 106 can iteratively (e.g., periodically, regularly, in real-time or near real-time, continuously) update the performance metric to determine subsequent slice sizes to be applied in real-time (or near real-time) to dynamically process new frames and slices. For example, the metric system 106 can update metrics to refine future slicing configurations.

In some implementations, the slice stage can be the stage in the slicing pipeline in which the system 100 can determine slice parameters for current workloads. The system 100 can include at least one slice system 108. The slice system 108 can determine a second slice parameter based at least on the at least one performance metric. For example, during slice stage the slice system 108 can analyze performance data to calculate the next slice size. In some implementations, the slice system 108 can determine the slice parameter and/or otherwise adjust slicing configurations dynamically by using real-time (or near real-time) feedback from operational metrics. The second slice parameter can be a refined slice size to reduce latency and maximize throughput. In some implementations, the second slice parameter is further determined based at least on maintaining the second slice parameter within at least one operational range (e.g., minimum slice threshold and maximum slice size) of the processing component. For example, the slice system 108 can ensure slices remain within the processing limits of the accelerator system 104.

In some implementations, the updating of the at least one performance metric and the determining of the second slice parameter and a plurality of subsequent slice parameters can be periodically performed during runtime of the processing component. That is, the system 100 can be dynamic by continuously and/or periodically updating slicing size based on real-time (or near real-time) performance data (e.g., latency measurements, throughput statistics, communication delays, and/or processing overhead). The slice parameter can be updated by the slice system 108 to match workload and latency requirements of the system 100. That is, the slice parameter can be updated dynamically to meet processing constraints. For example, the slice parameter can be a new slice size determined by the slice system 108 based on real-time (or near real-time) performance metrics, such as latency and throughput.

In some implementations, the second slice parameter can be a new slice size representing a number of slices per frame. Additionally, the determination of the parameter by the slice system 108 can be based on a latency metric (e.g., a performance metric) representing the time taken by the accelerator system 104 to process a single slice or a subset of slices. In some implementations, the determination of the parameter by the slice system 108 can be based on communication delay metric representing time occurred in transmitting slices to the accelerator system 104. Additionally, the determination of the parameter by the slice system 108 can be based on communication delay metric representing time occurred in transmitting slices to the accelerator system 104. In some implementations the determination of the parameter by the slice system 108 can be based on slice throughput metric representing the number of slices processed by the accelerator system 104 over a period of time. In some implementations the determination of the parameter by the slice system 108 can be based on a processing efficiency metric representing a ratio indicating how efficiently (e.g., processing time relative to the capacity of the system 100) the accelerator processes slices in comparison to maximum capacity (e.g., clock cycles used per slice).

In some implementations, the slice system 108 can determine second slice parameter based at least on updating the second slice parameter to satisfy the at least one operational range of the processing component and based at least on the at least one performance metric. For example, a performance metric can be a frame rate (e.g., time interval available for processing all or some slices of a frame) of the at least one first frame. In this example, the total time to process N slices can satisfy a total time formula (e.g., 33 ms for a frame rate of 30 fps):

$$SLICE > \frac{( L * N + OVERHEAD * \frac{N}{CLK} )}{( \frac{33}{{frame}_{size}} - A * \frac{N}{CLK} )}$$

where L can be the initial latency per slice, N can be the number of slices per frame, OVERHEAD can be the additional processing delay for each slice, frame_{size} can be the total size of the frame in bytes, SLICE can be the size of each individual slice, A can be the accelerator-specific coefficient (e.g., the processing cycles required per unit of slice size) related to slice processing time, and CLK can be the clock frequency of the accelerator system 104.

Additionally, the slice size can satisfy the minimum slice size requirement of the accelerator system 104:

$$SLICE > {MIN}_{SLICE}$$

wherein MIN_{SLICE} can be the minimum slice size defined by the hardware constraints of the accelerator system 104.

Thus, the second slice size (e.g., second slice parameter) and/or optimal slice size can be determined as:

$${OPT}_{SLICE} = max ( {MIN}_{SLICE} , \frac{( L * N + OVERHEAD * \frac{N}{CLK} )}{( \frac{\frac{1.1}{fps}}{{frame}_{size}} - A * \frac{N}{CLK} )} )$$

where the formula incorporates a 10% buffer to account for operational variability.

In some implementations, a first restriction in slice size optimization can be that smaller slice sizes can result in improved latency performance. For example, when the slice size decreases, latency can improve up to a specific threshold slice size. That is, once the slice size drops below this threshold, latency can increase significantly. In some examples, an ISP (e.g., image signal processor) operating at 700 MHz can exhibit reduced latency and/or optimal performance with a slice size above 200. In another example, performance degradation can occur when the slice size is reduced below 200. That is, the first restriction can ensure that slice sizes are small enough to reduce latency while avoiding significant increases in overhead.

In some implementations, a second restriction in slice size determination can be that the slice size can be constrained by the processing capacity of the accelerator (e.g., accelerator system 104) within the time interval for at least one (e.g., each) frame. For example, with a frame rate of 30 fps, each frame can be processed within 33 ms. That is, the second restriction ensures that the accelerator system 104 processes slices within the available frame interval, maintaining the throughput of the system 100. In some implementations, the slice system 108 can ensure the slice size satisfies:

$$33 * ( \frac{SLICE}{{frame}_{size}} ) > ( \frac{L * N + OVERHEAD * N}{CLK} + A * \frac{SLICE * N}{CLK} )$$

where at least one (e.g., each) term accounts for processing time, overhead, and communication delays within the frame interval.

In some implementations, for other frame rates the slice system 108 can recalculate slice parameters to accommodate different time intervals per frame. In some implementations, the slice system 108 can dynamically adjust the slice size (e.g., slice parameter) to meet and/or satisfy the second restriction based on real-time (or near real-time) performance metrics provided by the metric system 106. For example, the slice system 108 can calculate the adjusted and/or optimal slice size for varying workloads to facilitate efficient processing without exceeding the operational limits of the accelerator.

In another example, a performance metric can be a clock frequency of the processing component. In this example, the slice system 108 can use the clock frequency to determine the number of operations the accelerator system 104 can perform (e.g., per second). In yet another example, a performance metric can be a communication delay (e.g., time to transfer slices). In yet another example, a performance metric can be a processing overhead (e.g., additional time needed by the accelerator system 104).

Additionally, the update by the slice system 108 can occur using at least one artificial intelligence (AI) model (e.g., random forest regression, neural network, support vector machine, gradient descent model, and/or any machine learning algorithm). That is, while the operational range itself (e.g., minimum slice threshold and maximum slice size) can be static, determining the optimal slice size within this range can be dynamic. The AI model of the slice system 108 can be used to model real-time performance metrics, such as timing data, communication delay, and processing capacity, to select a slice size that is not too small (e.g., causing inefficiency due to overhead) and not too large (e.g., exceeding processing capacity). For example, the slice system 108 implementing the AI model can predict slicing configurations for varying workloads. In this example, the slice system 108 can apply predictions to dynamically update slice sizes in real-time (or near real-time).

In some implementations, the at least one AI model can be a random forest regression model and/or a gradient descent model. For example, the random forest regression model can use a set of decision trees to evaluate input performance metrics such as latency and throughput to predict a slice size. In this example, the slice system 108 can implement a random forest regression model to aggregate results from multiple trees to select a slice size optimized for the given workload. In another example, the gradient descent model can iteratively minimize a loss function based on latency and processing time to compute an updated slice size. In this example, the slice system 108 can implement a gradient descent model to adjust slice size by calculating gradients of the loss function with respect to the performance metrics.

The slice system 108 can include any one or more artificial intelligence models (e.g., machine learning models, supervised models, neural network models, deep neural network models), rules, heuristics, algorithms, functions, or various combinations thereof to perform operations including predicting slice sizes such as adjusting parameters for real-time workloads. That is, slice system 108 can include a neural network and/or machine-learning (ML) model trained to analyze latency and throughput metrics for dynamic slicing. In some implementations, the slice system 108 can output adjusted slice parameters (e.g., slice size, number of slices per frame, optimal transmission intervals, and/or any processing configuration). For example, the output can be a recommended slice size to reduce communication overhead. In another example, the output can be a latency threshold adjustment to balance processing efficiency and real-time constraints. In some implementations, the predicted slice configuration can be provided to slice system 108 to perform runtime slicing updates.

In some implementations, the slice system 108 can maintain, execute, train, update, and/or otherwise process, refile, or apply one or more artificial intelligence (AI) models during the slicing parameter adjustment stage. In some implementations, the AI model(s) can include any type of supervised or unsupervised AI model capable of predicting slice configurations (e.g., gradient-based optimizers, reinforcement learning agents) to enhance processing efficiency. For example, the AI model(s) can be trained and/or updated to identify patterns in latency and throughput metrics, among other performance indicators. The AI model(s) can be or include a transformer-based model (e.g., a generative pre-trained transformer (GPT) model, a bidirectional encoder representations from transformers (BERT)). The machine-learning model(s) can be or include a recurrent neural network (RNN) model, in some implementations. The slice system 108 can execute the AI model to generate outputs. The slice system 108 can receive data to provide as input to the AI model(s), which can include latency metrics, communication delays, slice size configurations, and/or any performance data.

In some implementations, the system 100 can configure (e.g., train, update, fine-tune, apply transfer learning to) the model(s) of the slice system 108 by modifying or updating one or more parameters, such as weights and/or biases, of various nodes of the AI model responsive to evaluating estimated outputs of the AI model (e.g., generated in response to receiving training examples in a training dataset, such as a training dataset including latency measurements, throughput statistics, and slice size configurations). The slice system 108 can be or include various neural network models, including models that can operate on or generate data including but not limited to slicing parameters, performance metrics, latency predictions, and/or various combinations thereof.

In some implementations, the slice system 108 can be configured (e.g., trained, updated, fine-tuned, has transfer learning performed, etc.) based at least on the training data of the at least one training dataset (e.g., communication latency data, slice throughput data, processing efficiency metrics). For example, one or more example latency values and/or slice size configurations of the training data can be applied (e.g., by the system 100, or in a pre-training process performed by the system 100 or another system) as input to the slice system 108 to cause the slice system 108 to generate an estimated output. The estimated output can be evaluated and/or compared with actual performance metrics (or ground truth data) of the training data that correspond with the one or more example latency values and/or slice size configurations, and the AI model of the slice system 108 can be updated based at least on the discrepancies and/or performance gaps. For example, based at least on an output of a latency prediction model, one or more parameters (e.g., weights and/or biases) of the AI model of the slice system 108 can be updated.

In some implementations, responsive to determining and/or otherwise updating the performance metric, the slice system 108 can determine another slice parameter (e.g., third slice parameter) based at least on the at least one performance metric. For example, the slice system 108 can refine slice sizes to further improve processing throughput. In some implementations, the slice system 108 can apply, in real-time, the slice parameter to the processing component (e.g., the accelerator system 104) to cause subsequent processing (e.g., in the downstream system 110) of at least one frame (e.g., fourth frame) into a plurality of slices (e.g., fourth slices) based at least on the slice parameter.

In some implementations, the processing stage can be the stage in the slicing pipeline in which the system 100 can execute final processing of the determined slices. The system 100 can include at least one downstream system 110. The slice system 108 can apply the second slice parameter to the processing component (e.g., the accelerator system 104) to cause subsequent processing by the downstream system 110 of at least one second frame into a plurality of second slices based at least on the second slice parameter. That is, the slice system 108 can cause, using the accelerator system 104, one or more next frames to be sliced and processed according to the new slice size. The application of the second slice parameter can occur in real-time (or near real-time) during ongoing operations of the system 100.

In some implementations, the downstream system 110 can be a real-time data processor, a video streaming platform, an AI inference engine, an autonomous driving system, and/or any high-performance computing system. For example, during processing stage the slice system 108 can apply the second slice parameter to the accelerator system 104 to cause the downstream system 110 to perform subsequent data analysis and/or rendering tasks. That is, causing the downstream system 110 to execute tasks efficiently based on updated slices can include rendering video frames, analyzing visual data, performing object detection, and/or refining model predictions. In some implementations, the downstream system 110 can process and/or otherwise execute a subsequent frame according to the second slice parameter by interfacing with the accelerator system 104 to maintain slicing performance. Additionally, while the slice system 108 interfaces with the accelerator system 104 to cause the subsequent processing on a downstream system 110 it should be understood that other configurations and/or architectures can be implemented and/or otherwise modified where system-specific constraints require alternative interconnects and/or custom hardware. For example, the slice system 108 can apply, cause, and/or otherwise interface with the downstream system 110 via an interface (e.g., PCIe, high-speed Ethernet, custom interconnect).

With reference to FIG. 2, an example flow diagram illustrating a method for adaptative frame partitioning in accelerated systems in a slicing pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 5A-5C), one or more computing devices or components thereof (e.g., as described in FIG. 6), and/or one or more data centers or components thereof (e.g., as described in FIG. 7).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for processing, updating, determining, and/or applying operations, in accordance with some implementations of the present disclosure. Various operations of method 200 can relate to improving the efficiency of frame slicing and processing in real-time (or near real-time) systems. Existing systems often rely on and/or use static slicing configurations, which can lead to increased latency and inefficient resource utilization. The existing technological problems can arise when these systems fail to dynamically adapt slice sizes to real-time performance metrics, resulting in bottlenecks in data transfer and processing inefficiencies. Method 200 of FIG. 2 can solve these technological problems by implementing dynamic slicing adjustments based on real-time (or near real-time) performance metrics, thereby improving latency and throughput while reducing communication overhead.

The method 200, at block 210, includes processing, by a processing component (e.g., e.g., accelerator) of a system-on-chip (SoC), at least one first frame into a plurality of first slices based at least on a first slice parameter (e.g., frame slice size). In some implementations, processing can include the processing circuits (e.g., processing circuitry, graphics processing unit (GPU), image signal processor (ISP), digital signal processor (DSP), and/or any hardware accelerator) dividing the frame data into slices and routing the slices for processing (e.g., parallel and/or sequential). In some implementations, the processing circuits can initialize the processing component based at least on updating a static configuration comprising at least one operational parameter (e.g., processing speeds, resolutions, frame rates) corresponding with at least one connected device (e.g., e.g., cameras, video sources, sensors, and/or any other peripherals such as gaming consoles or autonomous vehicle systems). In some implementations, the plurality of first slices represent a sub-section (e.g., at least one slice can be a partitioned portion of a full frame) of the at least one first frame.

The method 200, at block 220, includes updating at least one performance metric (e.g., performance of the accelerator in the SoC during frame slicing and processing) based at least on timing data corresponding with the processing of the plurality of first slices. In some implementations, the processing circuits can determine at least one metric based at least on timing data corresponding with the processing of the plurality of slices. In some implementations, updating can include the processing circuits recording and analyzing timing data for at least one (e.g., each and/or some) slice. That is, the timing data can be temporal measurement derived and/or otherwise obtained from processing durations, communications delays or intervals between event (e.g., reception of a slice, start of slice processing, completion of slice processing) during the processing of slices of frames.

In some implementations, the at least one performance metric (e.g., capturing operational characteristics) can include at least one of (i) a processing time of the plurality of first slices, (ii) a communication delay corresponding with providing the plurality of first slices from a slicing component to the processing component, (iii) a throughput corresponding with the plurality of first slices processed by the processing component, or (iv) a ratio of the communication delay to the processing time of the plurality of first slices. In some implementations, the timing data (e.g., the raw measurements from the processing and/or providing the performance metrics the underlying temporal information) can correspond to at least one of (i) a plurality of time stamps representing a start of processing and an end of processing for the plurality of first slices, (ii) a duration between a transmission of the plurality of first slices from the slicing component and a completion of processing by the processing component, (iii) an interval between a plurality of consecutive transmissions of the plurality of first slices from the slicing component, or (iv) a cumulative processing time of the plurality of first slices.

The method 200, at block 230, includes determining a second slice parameter (e.g., new slice size, such as the number of slices per frame) based at least on the at least one performance metric. In some implementations, determining can include the processing circuits analyzing latency and throughput metrics to calculate an improved slice size for subsequent frames. That is, the performance metrics can be a latency metric (e.g., time taken by the accelerator to process a single slice or a subset of slices), a communication delay metric (e.g., time occurred in transmitting slices to the accelerator), a slice throughput metric (e.g., a number of slices processed by the accelerator over a period of time), and/or a processing efficiency metric (e.g., a ratio indicating how efficiently the accelerator processes slices in comparison to maximum capacity, such as clock cycles used per slice). In some implementations, the second slice parameter can be further determined based at least on maintaining the second slice parameter within at least one operational range (e.g., minimum slice threshold and maximum slice size) of the processing component.

In some implementations, the second slice parameter can be further determined based on updating the second slice parameter to satisfy the at least one operational range of the processing component and based at least on the at least one performance metric corresponding to a frame rate (e.g., time interval available for processing all or some slices of a frame) of the at least one first frame, a clock frequency (e.g., determine the number of operations the accelerator can perform (e.g., per second)) of the processing component, the communication delay (e.g., minimum time and/or time required to transfer slices), and a processing overhead (e.g., additional time needed by the accelerator).

In some implementations, the updating can be performed by the processing circuits using at least one artificial intelligence (AI) model. That is, while the operational range itself (e.g., minimum slice threshold and maximum slice size) is static, determining the optimal slice size within this range is dynamic. The AI model can be used by the processing circuits to model real-time performance metrics, such as timing data, communication delay, and/or processing capacity, to select a slice size that is not too small (e.g., causing inefficiency due to overhead) and not too large (e.g., exceeding processing capacity). In some implementations, the at least one AI model can be or correspond to a random forest regression model or a gradient descent model. In some implementations, updating of the at least one performance metric and the determining of the second slice parameter and a plurality of subsequent slice parameters can be periodically performed during runtime of the processing component.

The method 200, at block 240, includes applying, in real-time (or near real-time, e.g., during the ongoing operation of the accelerator), the second slice parameter to the processing component to cause subsequence processing (e.g., cause the next frames to be sliced and processed according to the new slice size) of at least one second frame into a plurality of second slices based at least on the second slice parameter. In some implementations, the processing circuits can apply the second slice parameter to the processing component to cause subsequence processing of at least one second frame based at least on the second slice parameter. That is, applying can occur responsive to determining the second slice parameter. In some implementations, applying can include the processing circuits updating the slicing configuration for the accelerator based on the newly determined slice size. In some implementations, causing can include the processing circuits initiating the processing of the second frame slices with the updated slice size to maintain optimal system performance. In some implementations, the second slice parameter can be applied to the processing component by updating a slicing configuration (e.g., setting of the accelerator).

In some implementations, method 200 can further include updating the at least one performance metric based at least on a processing of at least one third frame into a plurality of third slices based at least one the second slice parameter. That is, the processing circuits can iteratively update the performance metric to determine subsequent slice sizes to be applied in real-time (or near real-time) to dynamically process new frames and slices. In some implementations, method 200 can further include determining a third slice parameter based at least on the at least one performance metric. In some implementations, method 200 can further include applying, in real-time (or near real-time), the third slice parameter to the processing component to cause subsequence processing of at least one fourth frame into a plurality of fourth slices based at least on the third slice parameter.

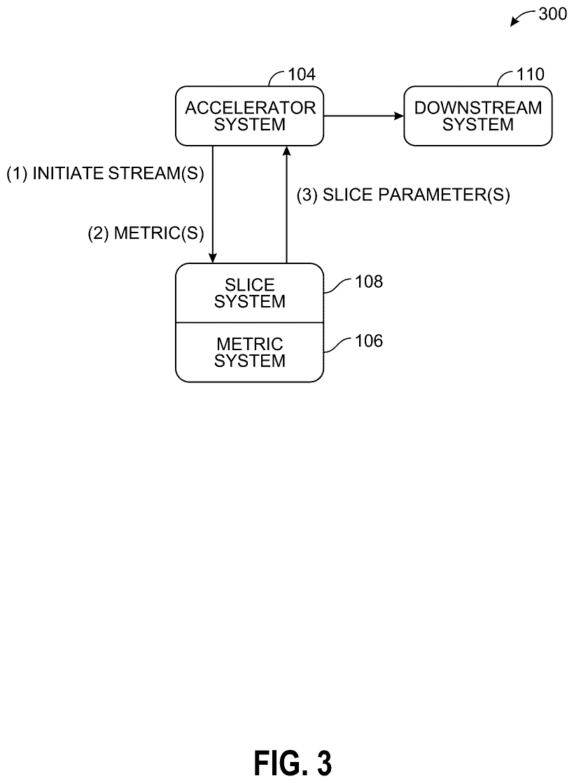

Referring now to FIG. 3, a block diagram of a slicing pipeline system 300 including the accelerator system 104, the metric system 106, the slice system 108, and the downstream system 110, in accordance with some implementations of the present disclosure. The slicing pipeline system 300 can includes the same or similar features as system 100. At block (1), the accelerator system 104 can initiate stream(s) by initializing the slice system 108 to begin processing frame data. For example, the accelerator system 104 can provide the initial frame data and command signals to the slice system 108, which prepares the data for slicing. That is, the accelerator system 104 sets up the slice system 108 to start the slicing process and facilities a continuous data stream for further processing.

At block (2), the metric system 106 can process and analyze metric(s) associated with the slicing and processing operations performed by the accelerator system 104. For example, the metric system 106 can compute real-time metrics such as slice processing latency, throughput, and/or communication delay. In another example, the metric system 106 can monitor the time intervals between slice completions. That is, the metric system 106 collect and provide performance data to the slice system 108 (e.g., part of the same component or separate components communicably coupled).

At block (3), the slice system 108 can generate and send updated slice parameter(s) to the accelerator system 104 based on the performance metrics provided by the metric system 106. For example, the slice system 108 can update the slice size dynamically to minimize latency and/or balance processing load. In another example, the slice system 108 can update the number of slices per frame in real time to accommodate varying workload requirements. That is, the slice system 108 can use the feedback from the metric system 106 to improve the slicing process throughout runtime (e.g., on the downstream system 110). In some implementations, the downstream system 110 can receive processed slices from the accelerator system 104 for final processing tasks such as rendering, object detection, and/or other data analysis. For example, the downstream system 110 can reconstruct video frames for streaming and/or analyze slices for real-time (or near real-time) decision-making in an autonomous driving system.

Additionally, the accelerator system 104 can (e.g., during runtime) fetch slice settings and/or parameters from the slice system 108 once per second, every 500 milliseconds, every frame, and/or any time period that matches the operational constraints or workload requirements of the system 300. The fetched and/or otherwise obtained slice settings and/or parameters can be used by the accelerator system 104 to create a profile (e.g., a data structure storing slice configurations and associated performance metrics). That is, the profile can be used to apply the slice settings and/or parameters from frames of upstream systems prior to processing and transmitting the slices to the downstream system 110. For example, the profile can be a set of predefined slice sizes and timing configurations for specific workloads, such as high-resolution video streaming and/or multi-camera input. The upstream system(s) (e.g., a multi-camera array, a video source server, an AI pre-processing system, and/or any data generation system) update configurations (e.g., accelerator engine clock, connected camera resolution, fps, number, bitrate settings, and/or any operational parameters) during runtime to adapt to system performance changes.

In some implementations, the upstream system can fetch and/or otherwise obtain the default slice setting and apply it during initialization during runtime. While the upstream system and accelerator system 104 are described herein as separate components, it should be understood that the upstream system and accelerator system 104 can be integrated within the same physical hardware or operate as virtual components in a distributed environment. In some implementations, the accelerator system 104 can update and provide updated timing data to the metric system (e.g., at block (2)) continuously, in real-time (or near real-time), and/or periodically.

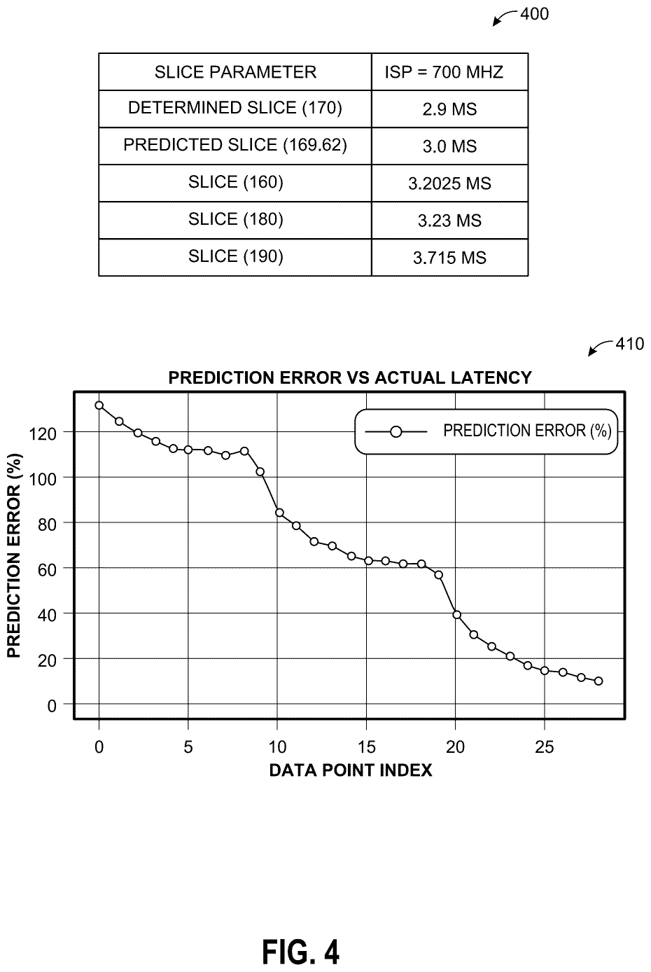

Referring now to FIG. 4, an example illustration of a diagram 400 and slice parameters and a graph 410 depicting example prediction error versus actual latency, in accordance with some implementations of the present disclosure. The table in diagram 400 can include slice parameters associated with an ISP bandwidth of 700 megahertz (MHZ). That is, the ISP clock can be the operating frequency of the image signal processor used to process slices. For example, 700 MHz can represent the clock speed at which the ISP executes processing cycles for frame data. The determined slice (170) corresponds to a latency of 2.9 ms and the predicted slice (169.62) has a predicted latency of 3.0 ms. Additionally, for comparative purposes, slice values of 160, 180, and 190 correspond to respective latencies of 3.2025 ms, 3.23 ms, and 3.715 ms. Thus, these values depict the correlation between slice size and the resulting latency, facilitating fine-tuning of slice parameters to minimize and/or reduce latency in real-time (or near real-time) processing scenarios and/or implementations.

Referring further to graph 410, the plot illustrates the prediction error as a percentage compared to actual latency, plotted against the data point index. For example, the initial data points depict higher prediction errors, with percentages exceeding 100%. As more data points are processed, the prediction error reduces, stabilizing below 20% after approximately 25 data points. Thus, this trend demonstrates the capability of system 100 to refine its latency predictions over time, improving accuracy with increased data. That is, graph 410 provides a visual representation of the dynamic adaptation of the system 100 to performance metrics, facilitating continuous and/or periodic improvement of slicing parameters. In some implementations, the data of diagram 400 and/or graph 410 can be used by the slice system 108 to dynamically update slice parameters during runtime. For example, the slice system 108 can rely on prediction models to update slice sizes based on observed latency trends. In another example, the system 300 can apply predictive adjustments to reduce the latency discrepancy between determined and predicted slice parameters.

### Example Language Models

In at least some implementations, language models, such as large language models (LLMs), small language models (SLMs), vision language models (VLMs), multi-modal language models (MMLMs), and/or other types of generative artificial intelligence (AI) can be implemented. Generally, the language models can process performance metrics, predict optimal configurations, and facilitate dynamic system adjustments in slicing pipelines. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/SLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/SLMsVLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/SLMs/VLMs/MMLMs/etc. can also include one or more diffusion block(s) (e.g., denoisers). The LLMs/SLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/SLMs/VLMs/MMLMs/etc. that include both encoder and decoder components like T5 (Text-to-Text Transformer) can be implemented to understand and generate content, such as for translation and summarization. These examples are not intended to be limiting, and any architecture type-including but not limited to those described herein—can be implemented depending on the particular implementation and the task(s) being performed using the LLMs/SLMs/VLMs/MMLMs/etc.

In various implementations, the LLMs/SLMs/VLMs/MMLMs/etc. can be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/SLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/SLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/SLMs/VLMs/MMLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 5A is a block diagram of an example generative language model system 500 suitable for use in implementing at least some implementations of the present disclosure. Generally, the example generative language model system 500 can predict slice parameters, analyze latency trends, and/or generate slicing configurations to improve frame partitioning and data throughput. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which can include an LLM, a SLM, a VLM, a multi-modal LM, etc.).

At a high level, the input processor 505 can receive an input 501 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 530 (e.g., LLM/SLM/VLM/MMLM/etc.). In some implementations, the input 501 includes plain text in the form of one or more sentences, paragraphs, and/or documents. Additionally or alternatively, the input 501 can include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 can combine text (or can omit text) with image data, audio data, video data, design data, USD data, and/or other types of input data, such as but not limited to those described herein. Taking raw input text as an example, the input processor 505 can prepare raw input text in various ways. For example, the input processor 505 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 can remove stopwords to reduce noise and focus the generative LM 530 on more meaningful content. The input processor 505 can apply text normalization, for example, by converting all characters to lowercase, removing accents, and/or or handling special cases like contractions or abbreviations to ensure consistency. These are just a few examples, and other types of input processing can be applied.

In some implementations, a RAG component 592 (which can include one or more RAG models, and/or can be performed using the generative LM 530 itself) can be used to retrieve additional information to be used as part of the input 501 or prompt. RAG can be used to enhance the input to the LLM/SLM/VLM/MMLM/etc. with external knowledge, so that answers to specific questions or queries or requests are more relevant—such as in a case where specific knowledge is required. The RAG component 592 can fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 501 can be generated using the query or input to the model (e.g., a question, a request, etc.) in addition to data retrieved using the RAG component 592. In some implementations, the input processor 505 can analyze the input 501 and communicate with the RAG component 592 (or the RAG component 592 can be part of the input processor 505, in implementations) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 can retrieve a prior stored conversation history—or at least a summary thereof—and include the prior conversation history along with the current ask/request as part of the input 501 to the generative LM 530.

The RAG component 592 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 592 and the embeddings of the chunks along with the embeddings of the query can be compared to identify the most similar/related embeddings to the query, which can be supplied to the generative LM 530 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/SLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLMSLM//VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 592 can implement a plugin, API, user interface, and/or other functionality to perform RAG. For example, a graph RAG plug-in can be used by the LLM/SLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 510 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy can depend on factors such as the language being processed, the task at hand, and/or characteristics of the training dataset. As such, the tokenizer 510 can convert the (e.g., processed) text into a structured format according to tokenization schema being implemented in the particular implementation.

The embedding component 520 can use any known embedding technique to transform discrete tokens into (e.g., dense, continuous vector) representations of semantic meaning. For example, the embedding component 520 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 can resize the data to a standard size compatible with format of a corresponding input channel and/or can normalize pixel values to a common range (e.g., 0 to 1) to ensure a consistent representation, and the embedding component 520 can encode the image data using any known technique (e.g., using one or more convolutional neural networks (CNNs) to extract visual features). In some implementations in which the input 501 includes audio data, the input processor 505 can resample an audio file to a consistent sampling rate for uniform processing, and the embedding component 520 can use any known technique to extract and encode audio features-such as in the form of a spectrogram (e.g., a mel-spectrogram). In some implementations in which the input 501 includes video data, the input processor 505 can extract frames or apply resizing to extracted frames, and the embedding component 520 can extract features such as optical flow embeddings or video embeddings and/or can encode temporal information or sequences of frames. In some implementations in which the input 501 includes multi-modal data, the embedding component 520 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 can apply an encoded representation of the input 501 to the generative LM 530, and the generative LM 530 can process the encoded representation of the input 501 to generate an output 590, which can include responsive text and/or other types of data.

As described herein, in some implementations, the generative LM 530 can be configured to access or use—or capable of accessing or using—plug-ins/APIs 595 (which can include one or more plug-ins, application programming interfaces (APIs), databases, data stores, repositories, etc.). For example, for certain tasks or operations that the generative LM 530 is not ideally suited for, the model can have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 595 to the plug-in/API 595, the plug-in/API 595 can process the information and return an answer to the generative LM 530, and the generative LM 530 can use the response to generate the output 590. This process can be repeated—e.g., recursively—for any number of iterations and using any number of plug-ins/APIs 595 until an output 590 that addresses each ask/question/request/process/operation/etc. from the input 501 can be generated. As such, the model(s) can not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. Generally, the example generative language model system 500 can predict slice parameters, analyze latency trends, and/or generate slicing configurations to improve frame partitioning and data throughput. For example, assume input text such as “Who discovered gravity” is tokenized (e.g., by the tokenizer510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 540 can convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 can generate a first token, and the generation mechanism 555 can apply the generated token as an input during a second pass. The process can repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 can output some decoded (e.g., vector) representation of the input being applied during a particular pass. The classifier 550 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 can select or sample a word or token based on a corresponding predicted probability (e.g., select the word with the highest predicted probability) and append it to the output from a previous pass, generating each word or token sequentially. The generation mechanism 555 can repeat the process, triggering successive decoder inputs and corresponding predictions until selecting or sampling a symbol or token that represents the end of the response, at which point, the generation mechanism 555 can output the generated response.

FIG. 5C is a block diagram of an example implementation in which the generative LM 530 includes a decoder-only transformer architecture. For example, the decoder(s) 560 of FIG. 5C can operate similarly as the decoder(s) 545 of FIG. 5B except each of the decoder(s) 560 of FIG. 5C omits the encoder-decoder self-attention layer (since there is no encoder in this implementation). As such, the decoder(s) 560 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 560. As with the decoder(s) 545 of FIG. 5B, each token (e.g., word) can flow through a separate path in the decoder(s) 560, and the decoder(s) 560, a classifier 565, and a generation mechanism 570 can use auto-regression to sequentially generate one token at a time until predicting a symbol or token that represents the end of the response. The classifier 565 and the generation mechanism 570 can operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 6 is a block diagram of an example computing device(s) 600 suitable for use in implementing some implementations of the present disclosure. Generally, the example computing device(s) 600 can execute slicing algorithms, process performance feedback, and/or communicate updated slice configurations across system components. Computing device 600 can include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 can comprise one or more virtual machines (VMs), and/or any of the components thereof can comprise virtual components (e.g., virtual hardware components). For non-limiting examples, one or more of the GPUs 608 can comprise one or more vGPUs, one or more of the CPUs 606 can comprise one or more vCPUs, and/or one or more of the logic units 620 can comprise one or more virtual logic units. As such, a computing device(s) 600 can include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, can be considered an I/O component 614 (e.g., if the display is a touch screen). As another example, the CPUs 606 and/or GPUs 608 can include memory (e.g., the memory 604 can be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 can represent one or more links or busses, such as an address bus, a data bus, a control bus, or a combination thereof. The interconnect system 602 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 can be directly connected to the memory 604. Further, the CPU 606 can be directly connected to the GPU 608. Where there is direct, or point-to-point connection between components, the interconnect system 602 can include a PCIe link to carry out the connection. In these examples, a PCI bus need not be included in the computing device 600.

The memory 604 can include any of a variety of computer-readable media. The computer-readable media can be any available media that can be accessed by the computing device 600. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 604 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 606 can be configured to execute at least some of the computer-readable instructions to control one or more components of the computing device 600 to perform one or more of the methods and/or processes described herein. The CPU(s) 606 can each include one or more cores (e.g., one, two, four, eight, twenty-eight, seventy-two, etc.) that are capable of handling a multitude of software threads simultaneously. The CPU(s) 606 can include any type of processor, and can include different types of processors depending on the type of computing device 600 implemented (e.g., processors with fewer cores for mobile devices and processors with more cores for servers). For example, depending on the type of computing device 600, the processor can be an Advanced RISC Machines (ARM) processor implemented using Reduced Instruction Set Computing (RISC) or an x86 processor implemented using Complex Instruction Set Computing (CISC). The computing device 600 can include one or more CPUs 606 in addition to one or more microprocessors or supplementary co-processors, such as math co-processors.

In addition to or alternatively from the CPU(s) 606, the GPU(s) 608 can be configured to execute at least some of the computer-readable instructions to control one or more components of the computing device 600 to perform one or more of the methods and/or processes described herein. One or more of the GPU(s) 608 can be an integrated GPU (e.g., with one or more of the CPU(s) 606 and/or one or more of the GPU(s) 608 can be a discrete GPU. In implementations, one or more of the GPU(s) 608 can be a coprocessor of one or more of the CPU(s) 606. The GPU(s) 608 can be used by the computing device 600 to render graphics (e.g., 3D graphics) or perform general purpose computations. For example, the GPU(s) 608 can be used for General-Purpose computing on GPUs (GPGPU). The GPU(s) 608 can include hundreds or thousands of cores that are capable of handling hundreds or thousands of software threads simultaneously. The GPU(s) 608 can generate pixel data for output images in response to rendering commands (e.g., rendering commands from the CPU(s) 606 received via a host interface). The GPU(s) 608 can include graphics memory, such as display memory, for storing pixel data or any other suitable data, such as GPGPU data. The display memory can be included as part of the memory 604. The GPU(s) 608 can include two or more GPUs operating in parallel (e.g., via a link). The link can directly connect the GPUs (e.g., using NVLINK) or can connect the GPUs through a switch (e.g., using NVSwitch). When combined together, each GPU 608 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 606 and/or the GPU(s) 608, the logic unit(s) 620 can be configured to execute at least some of the computer-readable instructions to control one or more components of the computing device 600 to perform one or more of the methods and/or processes described herein. In implementations, the CPU(s) 606, the GPU(s) 608, and/or the logic unit(s) 620 can discretely or jointly perform any combination of the methods, processes and/or portions thereof. One or more of the logic units 620 can be part of and/or integrated in one or more of the CPU(s) 606 and/or the GPU(s) 608 and/or one or more of the logic units 620 can be discrete components or otherwise external to the CPU(s) 606 and/or the GPU(s) 608. In implementations, one or more of the logic units 620 can be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 can include one or more receivers, transmitters, and/or transceivers that allow the computing device 600 to communicate with other computing devices via an electronic communication network, included wired and/or wireless communications. The communication interface 610 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 620 and/or communication interface 610 can include one or more data processing units (DPUs) to transmit data received over a network and/or through interconnect system 602 directly to (e.g., a memory of) one or more GPU(s) 608.

The I/O ports 612 can allow the computing device 600 to be logically coupled to other devices including the I/O components 614, the presentation component(s) 618, and/or other components, some of which can be built in to (e.g., integrated in) the computing device 600. Illustrative I/O components 614 include a microphone, mouse, keyboard, joystick, game pad, game controller, satellite dish, scanner, printer, wireless device, etc. The I/O components 614 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 can be include depth cameras, such as stereoscopic camera systems, infrared camera systems, RGB camera systems, touchscreen technology, and combinations of these, for gesture detection and recognition. Additionally, the computing device 600 can include accelerometers or gyroscopes (e.g., as part of an inertia measurement unit (IMU)) that allow detection of motion. In some examples, the output of the accelerometers or gyroscopes can be used by the computing device 600 to render immersive augmented reality or virtual reality.

The power supply 616 can include a hard-wired power supply, a battery power supply, or a combination thereof. The power supply 616 can provide power to the computing device 600 to allow the components of the computing device 600 to operate.

The presentation component(s) 618 can include a display (e.g., a monitor, a touch screen, a television screen, a heads-up-display (HUD), other display types, or a combination thereof), speakers, and/or other presentation components. The presentation component(s) 618 can receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that can be used in at least one implementations of the present disclosure. Generally, the example data center 700 can store and process large-scale slicing configurations, manage real-time system data, and/or facilitate distributed processing for frame partitioning systems. The data center 700 can include a data center infrastructure layer 710, a framework layer 720, a software layer 730, and/or an application layer 740.

As shown in FIG. 7, the data center infrastructure layer 710 can include a resource orchestrator 712, grouped computing resources 714, and node computing resources (“node C.R.s”) 716(1)-716(N), where “N” represents any whole, positive integer. In at least one implementation, node C.R.s 716(1)-716(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 716(1)-716(N) can correspond to a server having one or more of the above-mentioned computing resources. In addition, in some implementations, the node C.R.s 716(1)-7161(N) can include one or more virtual components, such as vGPUs, vCPUs, and/or the like, and/or one or more of the node C.R.s 716(1)-716(N) can correspond to a virtual machine (VM).

In at least one implementation, grouped computing resources 714 can include separate groupings of node C.R.s 716 housed within one or more racks (not shown), or many racks housed in data centers at various geographical locations (also not shown). Separate groupings of node C.R.s 716 within grouped computing resources 714 can include grouped compute, network, memory or storage resources that can be configured or allocated to support one or more workloads. In at least one implementation, several node C.R.s 716 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 712 can configure or otherwise control one or more node C.R.s 716(1)-716(N) and/or grouped computing resources 714. In at least one implementation, resource orchestrator 712 can include a software design infrastructure (SDI) management entity for the data center 700. The resource orchestrator 712 can include hardware, software, or some combination thereof.

In at least one implementation, as shown in FIG. 7, framework layer 720 can include a job scheduler 728, a configuration manager 734, a resource manager 736, and/or a distributed file system 738. The framework layer 720 can include a framework to support software 732 of software layer 730 and/or one or more application(s) 742 of application layer 740. The software 732 or application(s) 742 can respectively include web-based service software or applications, such as those provided by Amazon Web Services, Google Cloud and Microsoft Azure. The framework layer 720 can be, but is not limited to, a type of free and open-source software web application framework such as Apache Spark™ (hereinafter “Spark”) that can use distributed file system 738 for large-scale data processing (e.g., “big data”). In at least one implementation, job scheduler 728 can include a Spark driver to facilitate scheduling of workloads supported by various layers of data center 700. The configuration manager 734 can be capable of configuring different layers such as software layer 730 and framework layer 720 including Spark and distributed file system 738 for supporting large-scale data processing. The resource manager 736 can be capable of managing clustered or grouped computing resources mapped to or allocated for support of distributed file system 738 and job scheduler 728. In at least one implementation, clustered or grouped computing resources can include grouped computing resource 714 at data center infrastructure layer 710. The resource manager 736 can coordinate with resource orchestrator 712 to manage these mapped or allocated computing resources.

In at least one implementation, software 732 included in software layer 730 can include software used by at least portions of node C.R.s 716(1)-716(N), grouped computing resources 714, and/or distributed file system 738 of framework layer 720. One or more types of software can include, but are not limited to, Internet web page search software, e-mail virus scan software, database software, and streaming video content software.

In at least one implementation, application(s) 742 included in application layer 740 can include one or more types of applications used by at least portions of node C.R.s 716(1)-716(N), grouped computing resources 714, and/or distributed file system 738 of framework layer 720. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 734, resource manager 736, and resource orchestrator 712 can implement any number and type of self-modifying actions based on any amount and type of data acquired in any technically feasible fashion. Self-modifying actions can relieve a data center operator of data center 700 from making possibly bad configuration decisions and possibly avoiding underutilized and/or poor performing portions of a data center.

The data center 700 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 700. In at least one implementation, trained or deployed machine learning models corresponding to one or more neural networks can be used to infer or predict information using resources described above with respect to the data center 700 by using weight parameters calculated through one or more training techniques, such as but not limited to those described herein.

In at least one implementation, the data center 700 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 600 of FIG. 6—e.g., each device can include similar components, features, and/or functionality of the computing device(s) 600. In addition, where backend devices (e.g., servers, NAS, etc.) are implemented, the backend devices can be included as part of a data center 700, an example of which is described in more detail herein with respect to FIG. 7.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 600 described herein with respect to FIG. 6. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, a vehicle coupled to a trailer, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems sensor(s) 858 (e.g., Global Positioning System sensor(s)), RADAR sensor(s) 860, ultrasonic sensor(s) 862, LIDAR sensor(s) 864, inertial measurement unit (IMU) sensor(s)) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the HD map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over LTE, WCDMA, UMTS, GSM, CDMA2000, etc. The wireless antenna(s) 826 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may any number of wide-view cameras 870 on the vehicle 800. In addition, long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

One or more stereo cameras 868 may also be included in a front-facing configuration. The stereo camera(s) 868 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880 (A)-880 (B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to:
process, by a processing component of a system-on-chip (SoC), at least one first frame into a plurality of first slices based at least on a first slice parameter;
update at least one performance metric based at least on timing data corresponding with the processing of the plurality of first slices;
determine a second slice parameter based at least on the at least one performance metric; and
apply, in real-time, the second slice parameter to the processing component to cause subsequence processing of at least one second frame into a plurality of second slices based at least on the second slice parameter.

2. The system of claim 1, wherein the one or more processors are to:
initialize the processing component based at least on updating a static configuration comprising at least one operational parameter corresponding with at least one connected device.

3. The system of claim 1, wherein the at least one performance metric comprises at least one of (i) a processing time of the plurality of first slices, (ii) a communication delay corresponding with providing the plurality of first slices from a slicing component to the processing component, (iii) a throughput corresponding with the plurality of first slices processed by the processing component, or (iv) a ratio of the communication delay to the processing time of the plurality of first slices.

4. The system of claim 1, wherein the timing data corresponds to at least one of (i) a plurality of time stamps representing a start of processing and an end of processing for the plurality of first slices, (ii) a duration between a transmission of the plurality of first slices from a slicing component and a completion of processing by the processing component, (iii) an interval between a plurality of consecutive transmissions of the plurality of first slices from the slicing component, or (iv) a cumulative processing time of the plurality of first slices.

5. The system of claim 1, wherein the second slice parameter is further determined based at least on maintaining the second slice parameter within at least one operational range of the processing component.

6. The system of claim 5, wherein the second slice parameter is further determined based at least on:
updating, using at least one artificial intelligence (AI) model, the second slice parameter to satisfy the at least one operational range of the processing component and based at least on the at least one performance metric corresponding to a frame rate of the at least one first frame, a clock frequency of the processing component, a communication delay, and a processing overhead.

7. The system of claim 6, wherein the at least one AI model corresponds to a random forest regression model or a gradient descent model, and wherein the updating of the at least one performance metric and the determining of the second slice parameter and a plurality of subsequent slice parameters is periodically performed during runtime of the processing component.

8. The system of claim 1, wherein the one or more processors are to:
update the at least one performance metric based at least on a processing of at least one third frame into a plurality of third slices based at least one the second slice parameter;
determine a third slice parameter based at least on the at least one performance metric; and
apply, in real-time, the third slice parameter to the processing component to cause subsequence processing of at least one fourth frame into a plurality of fourth slices based at least on the third slice parameter.

9. The system of claim 1, wherein the plurality of first slices represent a sub-section of the at least one first frame, and wherein the second slice parameter is applied to the processing component by updating a slicing configuration.

10. The system of claim 1, wherein the one or more processors are comprised in at least one of:
a system for performing collaborative content creation for 3D assets;
a system for performing deep learning operations;
a system for generating or presenting one or more of augmented reality content, virtual reality content, or mixed reality content;
a system for performing simulation operations;
a system for performing real-time streaming;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system incorporating one or more virtual machines (VMs);
a system implemented at least partially in a data center; or
a system implemented at least partially using cloud computing resources.

11. One or more processors comprising processing circuitry to:
process, by a processing component of a system-on-chip (SoC), at least one first frame into a plurality of slices based at least on a first slice parameter;
determine at least one metric based at least on timing data corresponding with the processing of the plurality of slices;
determine a second slice parameter based at least on the at least one metric; and
apply the second slice parameter to the processing component to cause subsequence processing of at least one second frame based at least on the second slice parameter.

12. The one or more processors of claim 11, wherein the processing circuitry is to:
initialize the processing component based at least on updating a static configuration comprising at least one operational parameter corresponding with at least one connected device.

13. The one or more processors of claim 11, wherein the at least one metric comprises at least one of (i) a processing time of the plurality of slices, (ii) a communication delay corresponding with providing the plurality of slices from a slicing component to the processing component, (iii) a throughput corresponding with the plurality of slices processed by the processing component, or (iv) a ratio of the communication delay to the processing time of the plurality of slices.

14. The one or more processors of claim 11, wherein the timing data corresponds to at least one of (i) a plurality of time stamps representing a start of processing and an end of processing for the plurality of slices, (ii) a duration between a transmission of the plurality of slices from a slicing component and a completion of processing by the processing component, (iii) an interval between a plurality of consecutive transmissions of the plurality of slices from the slicing component, or (iv) a cumulative processing time of the plurality of slices.

15. The one or more processors of claim 11, wherein the second slice parameter is further determined based at least on maintaining the second slice parameter within at least one operational range of the processing component.

16. The one or more processors of claim 15, wherein the second slice parameter is further determined based at least on:
updating, using at least one artificial intelligence (AI) model, the second slice parameter to satisfy the at least one operational range of the processing component and based at least on the at least one metric corresponding to a frame rate of the at least one first frame, a clock frequency of the processing component, a communication delay, and a processing overhead.

17. The one or more processors of claim 16, wherein the at least one AI model corresponds to a random forest regression model or a gradient descent model, and wherein the updating of the at least one metric and the determining of the second slice parameter and a plurality of subsequent slice parameters is periodically performed during runtime of the processing component.

18. The one or more processors of claim 11, wherein the processing circuitry is to:
update the at least one metric based at least on a processing of at least one third frame into a plurality of second slices based at least one the second slice parameter;
determine a third slice parameter based at least on the at least one metric; and
apply, in real-time, the third slice parameter to the processing component to cause subsequence processing of at least one fourth frame into a plurality of third slices based at least on the third slice parameter.

19. The one or more processors of claim 11, wherein the plurality of slices represent a sub-section of the at least one first frame, and wherein the second slice parameter is applied to the processing component by updating a slicing configuration.

20. A method, comprising:
processing, using one or more processors by a processing component of a system-on-chip (SoC), at least one first frame into a plurality of first slices based at least on a first slice parameter;
updating, using the one or more processors, at least one performance metric based at least on timing data corresponding with the processing of the plurality of first slices;
determining, using the one or more processors, a second slice parameter based at least on the at least one performance metric; and
applying, using the one or more processors in real-time, the second slice parameter to the processing component to cause subsequence processing of at least one second frame into a plurality of second slices based at least on the second slice parameter.
